(19) United States
(12) Patent Application Publication
(10) Pub. No.: US 2013/0152515 A1
(43) Pub. Date: Jun. 20, 2013

(54) TABLET STORAGE SYSTEM AND USE THEREOF

(71) Applicants: Norma M. Valdez, Cambridge, MA (US); David Beach, Saint Augustine, FL (US)

(72) Inventors: Norma M. Valdez, Cambridge, MA (US); David Beach, Saint Augustine, FL (US)

(21) Appl. No.: 13/328,905

(22) Filed: Dec. 16, 2011

(51) Int. Cl. B65B 1/04; B67D 7/02

(52) U.S. Cl. 53/473; 222/129

(57) ABSTRACT

A storage device and system for storing whole, divisible tablets and the divided portions of those divisible tablets.

### FIELD OF THE INVENTION

The present invention relates to a system comprising a container for holding medicinal pills or tablets, including a separable receptacle or “basket” for holding divided portions of the medicinal pills or tablets to be ingested as partial doses over a period of time.

### BACKGROUND OF THE INVENTION

It is well known that in dispensing prescription drugs or medicines in pill or tablet form, a multi-day supply is furnished to a person with the instruction that a portion of the supply is to be taken each day until the total number of pills or tablets is exhausted. Thus, a prescription may call for twenty one units of a medicine to be ingested for seven days at the rate of three per day. The daily dosage is to be apportioned during a day, but it is less important that each dose be equally spaced from the others than that the total daily dosage be consumed during the day.

The problem here mentioned has been addressed in various ways. For example, U.S. Pat. No. 3,931,891 discloses a pill bottle having a pocket section into which a daily supply of pills can be placed after being separated from the total supply in the pill bottle. In addition, it has previously been proposed to provide medication receptacles with time indicators. See for example, U.S. Pat. No. 3,675,620, which describes a means for recording when a medicine dose is ingested. Other medication receptacles with time indicators include U.S. Pat. Nos. 1,425,456, 2,066,183, 2,111,637 and 3,960,713 which are directed to pill or tablet containers having a cap which is comprised of two relatively rotatable parts. U.S. Pat. No. 3,766,882 describes a container for holding pills, tablets or other medication provided with a bead extending around the opening at the top of the container, and a closure or lid adapted to snap over such bead adapted so that an index or pointer on the lid may cooperate with a scale of hour designations in response to turning of the closure or lid relative to the container.

U.S. Pat. No. 4,475,654 describes a storage and individualized dosage container for pills, tablets and the like having a hollow storage receptacle and a closure cap that includes a bottom wall and sidewalls which together define a compartment dimensioned to contain pills, tablets, etc. of the type stored within the receptacle in lesser quantity. The closure cap has a lid integral with the closure cap and is movable selectively relative to the opening therein to either close the opening or expose it to provide access to the contents of the compartment in the closure cap.

U.S. Pat. No. 4,634,011 describes a lid for a tablet bottle having an integral storage compartment for holding predetermined quantity of medication. The quantity of medication for administration during a set period can be removed from the bottle and placed in the compartment for ease of monitoring as to dosage rate throughout the period.

U.S. Pat. No. 5,397,017 provides a dispenser for storing and dispensing pills. The pill dispenser is readily attachable to the bottleneck of a water bottle, thus serving as a cap for the bottle, which obviates the difficulty of carrying a water bottle separately from pills.

The problem of monitoring daily doses for medications may be complicated when partial doses are being administered by splitting or dividing tablets prior to administration. This situation may arise when individuals take medication in a dosage form that may be difficult to swallow in whole form or where, in the case of children, the dose may be more than is required, necessitating that the tablet or pill be broken into smaller pieces. This problem not only arises in the realm of human consumption, but in animals and pets as well.

Tablet-splitting devices are well-known and have been in existence for many years. Examples are found in U.S. Patent Nos. U.S. Pat. No. 05,944,243, U.S. Pat. No. 02,655,259, U.S. Pat. No. 03,517,871, U.S. Pat. No. 04,173,826 , U.S. Pat. No. 04,179,806, U.S. Pat. No. 04,473,192, and U.S. Pat. No. 5,118,021. The '021 patent relates to a device for splitting a pill, tablet, capsule or caplet in a variety of shapes or sizes, having a base with a pill receptacle for receiving and centering the pill, a hinged top with a blade adapted for entering the receptacle and engaging and splitting the pill when the cap is closed. The device is adapted to be used as a cap for a container for storing the pills, tablets or caplets.

U.S. Pat. No. 6,474,525 also provides a pill splitter for use with pills of complex shapes, and has a bed which substantially conforms to one-half of the pill.

In U.S. Pat. No. 6,769,570, a medicine container is described, comprising an upstanding body having an open mouth and a hollow interior bounded by a sidewall and a separator secured in the body and defining upper and lower compartments, the upper compartment opening into the body open mouth, the lower compartment being accessible while the separator is secured in the body.

U.S. Pat. No. 7,100,797 describes a device for dispensing pills one at a time or one dose at a time. The device includes a unit chamber which fits within or is made integral with the rim of a pill bottle. The unit chamber includes a plurality of radial projections which project inwardly and are formed on the inner circumference of the chamber. Between the radial projections are defined discrete pill holding areas. As the bottle is inverted or angled upside-down for dispensing medication, pills will fall into the pill holding areas, one pill or dosage amount per area. The device also includes a dispensing cap secured to but rotatable relative to the unit chamber. The dispensing cap is provided with a pill-impermeable base having a window formed therethrough.

U.S. Pat. No. 7,240,795 describes a multiple compartment pill dispenser having a rotatable cap mechanism with two holes associated with the cap which are displaceable to be aligned with each of the compartments of the dispenser. There are two different sized holes, one for small pills and one for large pills. The dial cap mechanism is used to rotate one of the two holes into alignment with a particular pill compartment and allow a pill to be dispensed therefrom. As a closure device, an alignment plate is rotatably mounted in the cap mechanism. The alignment plate also includes two different sized holes, identical in diameter, respectively, to the two holes in the cap mechanism.

Despite the availability in the prior art of dosage form holders or receptacles, dispensers, or splitting platforms, none discloses a device as provided by the subject invention which has the unique and unexpected advantages as described herein.

### BRIEF DESCRIPTION OF THE INVENTION

It is an object of the present invention to provide an improved dosage form container that facilitates the administration and ingestion of a proper daily dosage of medication, including a medication contained in a divisible dosage form.

The subject invention comprises a packaging system used for shipping and storing pharmaceutical dosage forms, e.g., tablets, wherein the packaging includes a conventional plastic storage bottle having a neck for receiving a closure means such as a screw-top cap (including a cap adapted as a child-proof cap), and further comprising a separable receptacle insertable within the bounds of, or nested within, the neck of the bottle. The receptacle preferably conforms to the shape of the bottle neck and can be envisioned as a “basket” for holding tablets or tablet portions separate from the main storage compartment provided by the bottle. Accordingly, in a preferred embodiment of the invention, the receptacle is substantially the same height dimension of the bottle neck and is slightly smaller in diameter than the width of the inner opening of the neck so that it can be easily inserted or removed from the neck of the bottle. The receptacle preferably rests below the induction seal or other sealing surface of the bottle neck, more preferably about 0.030 inches below the sealing surface, to allow for a single closure means to close both the container (pill bottle) and the receptacle.

The receptacle preferably has an open top, a floor preferably shaped to conform to the inner diameter of the bottle neck, such as a substantially circular or elliptical shape, and bounding side wall around the entire circumference of the floor. The bounding side wall may also be other geometrical shapes, e.g., having three or more side walls around a non-circular or non-elliptical (e.g., triangular or quadrangular) floor.

The receptacle can have one or more compartments to receive and hold tablet portions that have been divided from a whole or previously divided tablet. In one embodiment, the receptacle includes dividers, e.g., walls, which provide separate compartments within the receptacle for receiving and holding tablets or tablet portions. These walled divisions are preferably formed as thin walls, perpendicular to the floor of the receptacle, and are commonly referred to in the art as “scallops.” In a preferred embodiment, the receptacle comprises four equal compartments formed by two walls which intersect at the center of the receptacle.

More preferably, the receptacle further comprises a means, such as a spindle, for easy grasping of the receptacle, which can facilitate removing the receptacle from the neck of the bottle and replacing the receptacle within the bottle, as desired for use. A most preferred embodiment comprises a spindle formed at the intersection of the divider walls, and extending slightly above the top of the wall to facilitate grasping the spindle for removal of the receptacle from and insertion of the receptacle into the neck of the bottle.

In another embodiment, the receptacle comprises a sharp edge to use as an aid to break divisible tablets (by positioning the tablet score on the edge and pressing against it). Preferably, the sharp edge is sharp enough to facilitate tablet breaking but is not so sharp as to present a risk to the user of cutting the skin if coming into contact with the sharp edge. The sharpened edge can be provided on the upper or top edge of the divider wall or the bounding wall (i.e., the open end of the receptacle basket.)

The neck/basket can be made compatible to a wide range of bottle sizes, including conventional 33/400 for 40 cc, 60 cc, or 75 cc capacity bottles, or 38/400 neck finishes for 75 cc, 100 cc, 120 cc, or 150cc capacity bottles.

Advantageously, the subject invention provides a means to enable a person to assure that the proper dosage of a medicine is taken. The system comprising the pill container or bottle and receptacle is preferably useful for storing whole tablets in the bottle, and storing divided tablet portions in the receptacle for later administration. The receptacle can also be used to store a whole tablet or tablets to separate a daily dose from the tablets in the pill container or bottle.

The system of the subject invention further can provide an advantage wherein the tablet segments, once divided from the whole tablet, will be “stored” in the same container closure system as used to develop stability of the product, thereby eliminating concerns over degradation of the tablet segments (also referred to as “tablettes”) which would occur if they are stored in some other type container or left exposed to the environment

The receptacle aspect of the system according to the subject invention can also reduce or eliminate the need for using a separate “void filler,” such as a low moisture-content cotton or rayon as is typically used in pill storage bottles. The receptacle occupies the neck space of the bottle and thereby can further prevent the contents from being fractured during shipment.

In carrying out the invention there is provided a pill or tablet container, e.g., a conventional pill bottle having a neck, and a separate receptacle that can be inserted into and removed from the neck. The system of the subject invention thus provides a whole-dosage supply compartment (the interior holding area of the pill bottle) for holding whole or undivided tablets, and a second divided-dose receptacle (the “basket” formed by the receptacle) for holding divided doses following division of the whole tablets. The bottle can be provided with the usual closure, e.g., a screw-top cap, which closes both compartments when in place.

Thus, a subject using the bottle and receptacle system of the invention can obtain the bottle/receptacle combination containing a supply of whole tablets within the main holding area of the bottle. When a divided portion of the dosage is desired, the receptacle is removed for access to the supply of whole tablets, whereby the whole tablet can be removed and divided. Rather than replace the unused divided tablet portion to the supply compartment, the tablet portion can be placed into the receptacle compartment. The receptacle, containing the tablet portion can then be inserted into the neck of the bottle and the closure means attached to close both the bottle and receptacle.

A further advantage can be realized by an embodiment of the subject invention wherein the receptacle comprises a plurality of compartments. In this embodiment, if the whole tablet is divided into more than one portion, each portion can then be placed into a separate compartment of the receptacle for later use or administration of one of the tablet portions.

It is yet another object and feature of the invention to provide for a pill splitting device which is an integral part of a container for storing a plurality of tablets to be split, and further comprising a receptacle for storing the split tablets. Accordingly, another advantage of the subject invention can result in providing an embodiment wherein the receptacle comprises a sharp edge useful for dividing the tablet. This embodiment can replace the need for a separate tablet splitter device.

In accordance with the use of a system according to the subject invention, the user can remove a whole tablet, divide the dosage using the sharpened edge of the receptacle to divide the dose, and replace the divided tablet portion in the receptacle for storage using the single unit comprising the storage bottle/receptacle/splitter combination according to the subject invention.

Other objects and features of the invention will be readily apparent from the accompanying drawings and description of the preferred embodiments which follow.

Features and advantages of the invention will be gained from the foregoing and from the description of a preferred embodiment thereof which follows.

The description and drawings provided herein, including the preferred embodiments described and shown, are intended for exemplary purposes only and are not intended to be limiting to the breadth or scope of the invention.

### BRIEF DESCRIPTION OF THE DRAWINGS

FIG. 1 is an exploded front view of a tablet or pill bottle according to the present invention comprising a whole-tablet storage bottle, a divided-tablet or divide-pill storage receptacle, and a closure means;

FIG. 2 is a top view of an embodiment of a divided-tablet receptacle of the subject invention showing the bounding wall and floor, and the divider walls forming compartments within the receptacle, the divider walls intersecting at a central spindle for removing and inserting the receptacle from or in the neck of the storage bottle; also illustrated in FIG. 2 is a sharpened edge formed on a top edge of a dividing wall which can serve as a tablet-splitter.

FIG. 3 shows a cross-sectional, perspective view of the receptacle illustrated in FIG. 2, illustrating the compartments formed within the receptacle by the dividing wall, and further showing the spindle formed at the intersection of two dividing walls; further illustrated is the divider wall comprising a sharpened edge serving as a tablet-splitter device.

FIG. 4 is a side, cross-sectional view of a storage bottle and receptacle of FIG. 1 as associated together as a system.

FIG. 5 is a photograph of one embodiment of a system comprising a storage bottle and receptacle of the subject invention.

### DETAILED DESCRIPTION OF THE INVENTION

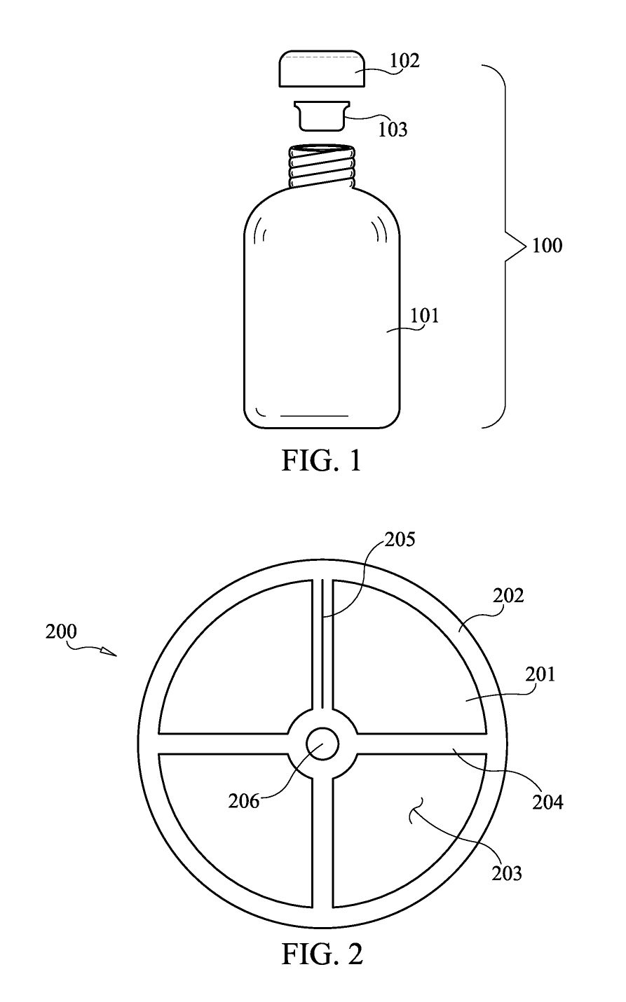

Referring to the drawings, FIG. 1 shows, in exploded view, an embodiment of the tablet container 100 in accordance with a system of the subject invention. Illustrated are the storage container 101 for holding and storing whole tablets or other dosage forms, shown here as a conventional, substantially cylindrical member, having a neck which is open at its top end and providing a main storage area within the storage bottle. A closure means 102, which can be a conventional screw-cap closure, is provided for the usual purpose. It would be understood that child-resistant closures or a snap-on cap could be used in conjunction with storage bottle 101.

Also shown as part of the subject invention is a receptacle 103 which is dimensioned to conform to, and be placed inside, the neck of the storage bottle 101, such that the storage bottle and receptacle can be enclosed by closure means 102.

FIG. 2 illustrates the detail of a receptacle 200 having at least one compartment 201 formed by the bounding wall 202 and floor 203 of the receptacle. The bounding wall and floor are shown as substantially circular in shape, but can be any shape so long as it is formed to nest within the neck of a storage bottle. For example, if the neck of the bottle is square or rectangular, the receptacle can be shaped to conform to the shape of the neck. However, the shapes of the neck and receptacle are not required to match, so long as the receptacle is formed to be retained in position in the neck of the storage bottle, and does not comprise a shape that allows the receptacle to fall within the main storage area of the storage bottle.

Preferably, the receptacle comprises at least one divider wall 204, perpendicular to the floor 203 of the receptacle 200 and, when two or more divider walls are present, they are preferably perpendicular to one another to provide compartment areas of equal size. The compartment areas are intended to hold whole tablets or divided tablet portions for later use. Further illustrated in FIG. 2 is a divider wall, comprising a sharpened edge 205, which can serve as a tablet-splitter. To carry out tablet splitting using the receptacle adapted for such use, the tablet can be placed onto the sharpened edge at a position desired or breaking or dividing of the tablet, and can be split by applying pressure to the tablet against the sharpened edge. The sharpened edge is preferably sharp enough to narrow and focus the pressure point of the tablet to facilitate breakage, but not sharp enough to cause damage to the skin of the user in the event of inadvertent contact with the sharpened edge.

Also illustrated in FIG. 2 is a center spindle 206 that is formed in the center of the receptacle to facilitate grasping of the receptacle for its removal and replacement relative to the neck of the bottle. Preferably, the receptacle comprises two intersecting divider walls having the center spindle positioned at the intersection of the divider walls.

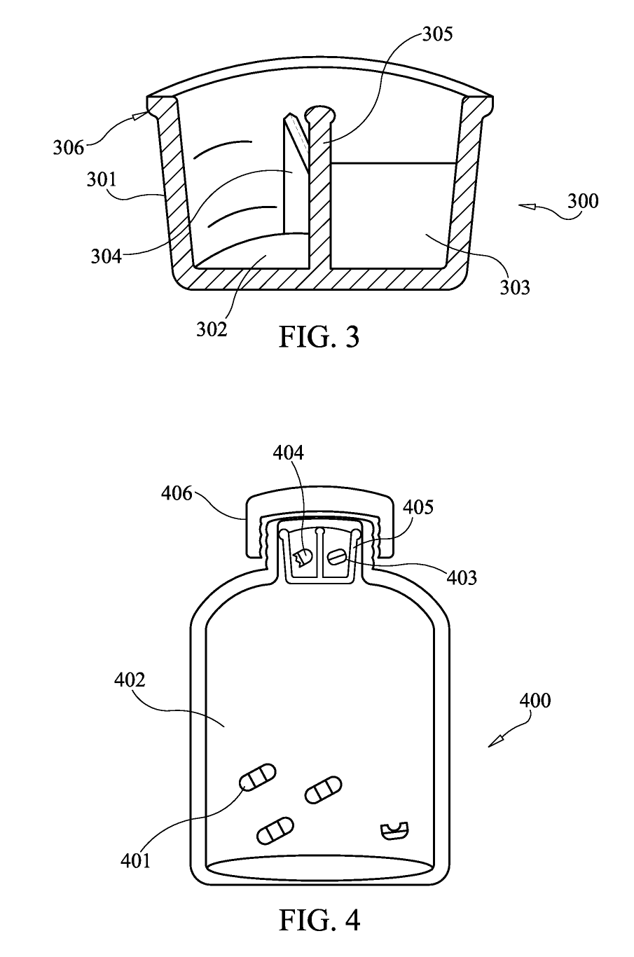

FIG. 3 is a cross-sectional view of a receptacle 300 according to the subject invention, illustrating in more detail the divider walls and spindle elements. Specifically, receptacle 300 has a bounding wall 301 and a floor 302. Also shown are divider walls 303 and 304, intersecting at spindle 305.

In a preferred embodiment, the height of spindle 305 is such that it does not exceed the upper edge of the receptacle wall 301 in order to allow closing of both the storage bottle and receptacle by the closure means. In addition, the height of divider wall 303 and 304 is preferably less than the spindle height so that the user can easily grasp the spindle, for removal and replacement of the receptacle, without grasping the divider wall.

Also shown in FIG. 3 is retention means 306, shown as a formed “lip” around the top edge of the bounding wall 301, which can be provided to engage a corresponding receiving means inside the inner wall of the neck of the bottle to retain the receptacle within the bottle neck and prevent its passage through the bottle opening and into the main storage are of the storage bottle. Additional retention means, such as threads, can optionally be formed on the outer wall of the receptacle to engage corresponding threads on the inner wall of the neck of the bottle to provide a receptacle that can be threadably positioned or screwed into place within the neck of the storage bottle.

FIG. 4 shows a cross-sectional side view of a storage bottle 400, receptacle 405, and closure means 406 of FIG. 1 as associated together when closed. Shown are whole, divisible tablets 401 stored in the main storage area 402 of the storage bottle 400, and tablet portions 403 and 404 stored in the compartmented receptacle 405 as described.

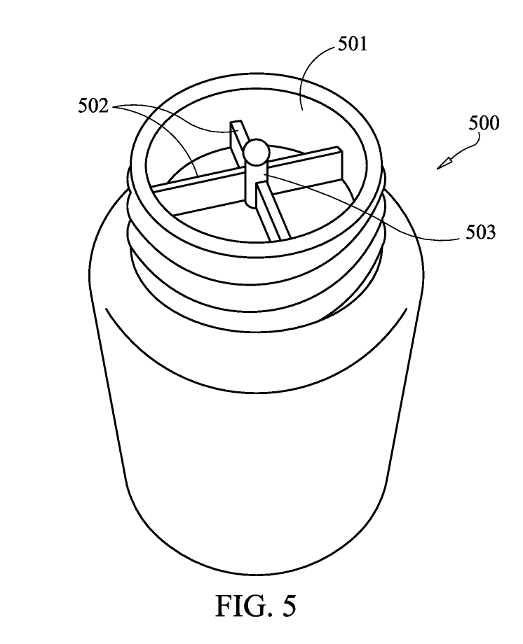

FIG. 5 is a photograph of a storage container 500 and compartmented receptacle 501, showing divider walls 502 and center spindle 503 as contemplated for an embodiment of the subject invention.

The manufacture of the components of the subject invention is preferably carried out by plastic molding processes that are conventional and well known in the art. Plastic storage bottles for pharmaceutical tablets are available in the market, and the receptacle for use within the plastic storage bottle can be molded according to the dimensions and specifications for the available storage bottles. Moreover, should modifications to the storage bottle be required or desired to conform to particular features of the receptacle, such modification would be readily available in accordance with standard practices of the plastic molding industry.

The subject invention can preferably be used with readily divisible tablets and, more preferably, readily divisible tablets comprising an inactive breaking layer as described, for example, in U.S. Pat. Nos. 7,879,352 and 8,034,380, and used in accordance with the methods of U.S. Pat. Nos. 7,713,547 and 7,838,031. These patents, and their related parent or continuing patents or pending published applications, are included as part of this invention and are hereby incorporated by reference in their entirety.

Having thus described the invention it is clear that what may appear to be different embodiments could be provided without departing from the spirit and scope of the invention. Hence it is intended that the foregoing specification and the accompanying drawing be interpreted as illustrative rather than in a limiting sense.

1. A storage device for storing and dispensing a portion of a divided pharmaceutical tablet derived from a whole, divisible pharmaceutical tablet, said device comprising a receptacle comprising a floor and a bounding wall forming an open, tablet-portion holding area, wherein said receptacle is insertable and retainable within a neck of a pharmaceutical tablet storage bottle.

2. The device of claim 1, wherein said receptacle comprises at least one divider wall forming divided compartments within the tablet-portion holding area of the receptacle.

3. The device of claim 1 wherein said receptacle further comprises a center spindle for a user to grasp the receptacle and remove the receptacle from, and replace the receptacle within, the neck of the bottle.

4. The device of claim 3 wherein said divider wall comprises a sharpened edge as a tablet-splitter.

5. The device of claim 1 wherein said receptacle comprises a retaining member formed as an outer lip of the bounding wall, said retaining member corresponding to a receiving means on an inner wall of the bottle neck.

6. The device of claim 2 wherein the dividing wall comprises two intersecting walls forming four equivalent compartments.

7. The device of claim 1 further comprising a center spindle formed at the intersection of the intersecting divider walls.

8. A method for retaining and storing pharmaceutical tablet portions divided from a whole or a previously divided pharmaceutical tablet, said method comprising
providing a divided pharmaceutical tablet receptacle of claim 1; and
storing a divided pharmaceutical tablet portion within the receptacle.

9. The method of claim 8 wherein the method comprises the further steps of
removing the receptacle from the neck of a pharmaceutical storage bottle to access and remove a whole tablet from the main storage area of the storage bottle, and
replacing the receptacle containing a remaining divided pharmaceutical tablet portion within the neck of the bottle.

10. The method of claim 8 wherein the method further comprises the step of dividing the tablet using a tablet-splitter formed on the upper edge of a divider wall provided in the receptacle.

11. A system for storing a pharmaceutical tablet portion divided from a divisible pharmaceutical tablet, said system comprising
a storage bottle forming a storage compartment for receiving and storing a whole, divisible pharmaceutical tablet, said bottle including a neck integral therewith,
a separate and separable receptacle comprising a floor and a bounding wall forming an open, tablet-portion holding area, wherein said receptacle is insertable and retainable within a neck of a pharmaceutical tablet storage bottle, and
a closure means capable of closing the storage bottle and receptacle, together.

12. The system of claim 11, wherein said receptacle comprises at least one divider wall forming divided compartments within the tablet-portion holding area of the receptacle.

13. The system of claim 11 wherein said receptacle further comprises a center spindle for a user to grasp the receptacle and remove the receptacle from, and replace the receptacle within, the neck of the bottle.

14. The system of claim 13 wherein said divider wall comprises a sharpened edge as a tablet-splitter.

15. The system of claim 11 wherein said receptacle comprises a retaining member formed as an outer lip of the bounding wall, said retaining member corresponding to a receiving means on an inner wall of the bottle neck.

16. The system of claim 12 wherein the dividing wall comprises two intersecting walls forming four equivalent compartments.

17. The system of claim 16 comprising a center spindle formed at the intersection of the intersecting divider walls.

18. The system of claim 11 wherein the device further comprises a supply of divisible compressed tablets having an inactive breaking region formed in the tablet.

19. The system of claim 18 wherein the tablets are taller-than-wide and have the inactive breaking region formed between two active compositions.

20. The system of claim 18 wherein the tablets are compressed bilayer tablets having a top inactive layer and a bottom active layer wherein the bottom active layer is scored at least 70% therethrough.
